(19) United States
(12) Patent Application Publication
(10) Pub. No.: US 2004/0180150 A1
(43) Pub. Date: Sep. 16, 2004

(54) Decorative plastics product and method for forming the same

(76) Inventors: Kashichi Hirota, Tokyo (JP); Junji Fukuda, Tokyo (JP)

Correspondence Address: Jacobson Holman, 400 Seventh Street, N.W., Washington, DC, 20004-2218, US

(21) Appl. No.: 10/424,157

(22) Filed: Apr. 28, 2003

Related U.S. Application Data
(63) Continuation-in-part of application No. 10/384,071, filed on Mar. 10, 2003, now abandoned.

(51) Int. Cl. B29C 45/73

(52) U.S. Cl. 428/31; 264/328.16; 264/328.18

(57) ABSTRACT

The present invention provides an ornamental exterior component with a luster finished appearance and a method of forming the component at a low cost. The method of the present invention comprises the steps of mixing a lustrous material with a colored resin material or transparent resin material, setting the temperature of a molding die at a desired high temperature, injecting the resin material in its molten state into a molding cavity of the high-temperature molding die to rapidly heat the injected resin material, and reducing the temperature of the molding die to rapidly cool the resin material in the cavity, whereby a highly lustrous molding is formed with a smooth surface. Then, a transparent coating material is applied on the surface of the molding to finish the molding into a resin product having an excellent appearance.

### BACKGROUND OF THE INVENTION

1. Field of the Invention

The present invention relates to a method of forming an decorative plastics product, wherein a glossy or lustrous material such as metal or mica is mixed in a resin material, and the resulting mixture in its molten state is injected into a molding die to obtain the decorative plastics product. The present invention relates more particularly to a method of forming a decorative plastics product, which is suited for, but not limited to, producing a small-size product such as an exterior panel and frame for TV sets, personal computers and other electronic instruments, or an exterior panel for portable phones or other phones. The present invention also relates to an decorative plastics product formed through the above method.

2. Description of the Related Art

Despite of various attempts for adding a lustrous finish to a frame around a display screen of a TV set or a personal computer to provide enhanced appearance thereto, it is still in a situation where a lustrous product is hardly obtained through only a single coating process. Practically, after applying one coating material once, a transparent lustrous coating material is applied thereon. This lustrous coat finish has no applicability for products essentially having a low-cost requirement because it inevitably leads to increase in cost of production.

FIG. 1 is a sectional view showing the above conventional coating process. A polystyrene resin or ABS resin molding 1 for a frame of a personal computer or the like is first coated with an undercoat layer 3. The undercoat layer 3 is made of metallic or pearl material, and coated at a thickness of about 15 to 20μ. The undercoat layer 3 is then coated with a topcoat layer 5. The topcoat layer 5 is made of a lustrous transparent coating material, and coated at a thickness of about 15 to 20μ. If a metallic or pearl material is used as the undercoat layer 3 in this process, and the surface of the obtained undercoat layer is not smoothed, the uneven surface of the undercoat layer 3 will adversely affect on the topcoat layer 5 to be formed thereon. Specifically, if the surface of the undercoat layer 3 is not sufficiently smoothed, the surface smoothness and/or lustrous appearance of the topcoat layer 5 will be lost. In addition, during the process of applying the undercoat layer, the undercoat layer is subject to attachment of foreign particles or dirt. Thus, a significantly difficult and skilled operation will be forced to form the undercoat layer without any adverse affect on the topcoat layer.

A highly lustrous finish is also applied to interior and/or exterior components for automobiles, and an exterior component for motorcycles. A molding to be used therein is made of resin material such as polycarbonate resin, polyacetal resin, polypropylene resin or polyethylene resin. Such a material causes difficulty in maintain an adequate adhesiveness between the molding and an undercoat to be applied thereon, as compared to the process in FIG. 1. For this reason, a primer is typically coated on the molding to provide enhanced adhesiveness, and then an undercoat is applied thereon.

FIG. 2 is a sectional view showing such a typical conventional coating process. A molding 1′ constituting an interior and/or exterior component for automobiles, or an exterior component for motorcycles is made of the aforementioned resin material, i.e. polycarbonate resin, polypropylene resin or the like. A primer is coated on the surface of the molding 1′ to form a primer layer 7. The primer layer 7 has a thickness of 10 to 15μ. A metallic or pearl material is undercoated on the primer layer 7 to form an undercoat layer 3′. The undercoat layer 3′ has a thickness of 15 to 20μ. Then, the undercoat layer 3′ is coated with a lustrous transparent coating material to form a topcoat layer 5′. The topcoat layer 5′ has a thickness of 15 to 20μ.

The above finishing process for resin products requires two or more coating steps, resulting in increased production cost and product cost. In addition, the finished product has an increased thickness, which is also disadvantageous in terms of appearance.

### SUMMARY OF THE INVENTION

In view of the above conventional problems, it is an object of the present invention to provide a method capable of producing a highly lustrous molding efficiently and stably with a smooth surface through a molding process of rapidly increasing and reducing the temperature of a molding die, so as to eliminate unprofitable production costs and operational difficulties otherwise caused during production of decorative plastics products.

It is another object of the present invention to provide an decorative plastics product formed through the above method.

In order to achieve the above objects, the inventors focused in that in a molding process of decorative plastics products, the surface gloss or luster of a molding was determined by the surface temperature of a molding die, or a molding could be obtained with higher luster as the molding die had a higher surface temperature, and have finally completed the present invention. An decorative plastics product of the present invention is provided as a lustrous molding by injecting a fusible resin material in its molten state into a molding cavity of a molding die provided with a plurality of ducts for selectively cooling or heating the molding die, and has a temperature higher than that in an ordinary molding condition to be set for the fusible resin material. More specifically, the method of the present invention comprises the steps of mixing particles of lustrous material with a fusible resin material colored to a desired tone, allowing a heating medium to flow through a plurality of ducts of a molding die in such manner that the molding die is rapidly heated to have a given high temperature, injecting the resin material in its molten state into a molding cavity of the molding die while maintaining the above high temperature of the molding die, and in response to the completion of the injection of the molten resin material, allowing a cooing medium to flow through the ducts in such manner that the molding die is rapidly cooled to have a given low temperature. The method of the present invention provides a highly lustrous molding with excellent surface smoothness.

While the fusible resin material of the present invention is preferably selected from the group consisting of polystyrene resin, polycarbonate resin, ABS resin, polyacetal resin, polypropylene resin and polyethylene resin, the present invention is not limited to these resins, but any suitable fusible resin material may be used. The particles of lustrous material may be particles of pigment, metal such as aluminum, copper or brass, or micaceous mineral such as mica. Preferably, the particles have a size of 5 to 30μ. The particles of lustrous material are mixed with the resin material preferably at 5 to 10 weight % on the basis of the total weight.

The temperature of the molding die to be controlled is varied according to the fusible resin material to be used. The temperature of a molding die in an ordinary molding condition to be set, for example, for polystyrene resin is in the range of 40 to 60° C. By contrast, in the present invention, the temperature of the molding die is set in the range of 70 to 150° C. (with a range of 80 to 90° C. being preferred) during the injection process of the resin material, and set in the range of 60 to 70° C. during the cooling process of the injected resin material.

A transparent coating material may be overcoated on the smooth surface of the obtained molding only once to form a highly lustrous topcoat providing a metallic or pearl appearance without any undercoats

The resin product forming method of the present invention may be applied to any molding such as an interior or exterior component for automobiles, an exterior component for motorcycles, a frame for TV sets or personal computers, an exterior panel for portable phones or other phones.

The resin product forming method of the present invention can be completed by utilizing existing facilities. In addition, the method of the present invention can advantageously eliminate the need of the undercoating step in the conventional coating process, so as to not only prevent the problem of spots caused by the attachment of foreign particles to a molding or the invasion of dirt but also provide a simplified coating process capable of stably forming moldings with enhanced quality. These advantages allow the production cost of the molding to be properly reduced.

### BRIEF DESCRIPTION OF THE DRAWINGS

FIG. 1 is a sectional view showing coat layers of a conventional resin product serving as a frame for TV sets or the like.

FIG. 2 is a sectional view showing coat layers of another conventional resin product serving as an exterior component for automobiles or the like.

FIG. 3 is a front perspective view of a vehicle bumper formed by a method of the present invention.

FIG. 4 is a sectional view showing a coat layer of the bumper in FIG. 3.

FIG. 5 is a top plan view of a molding die for use in the method of the present invention.

FIG. 6 is a cross sectional view of the molding die in FIG. 5.

FIG. 7 is a longitudinal sectional view of the molding die in FIG. 5.

### DESCRIPTION OF THE PREFERRED EMBODIMENT

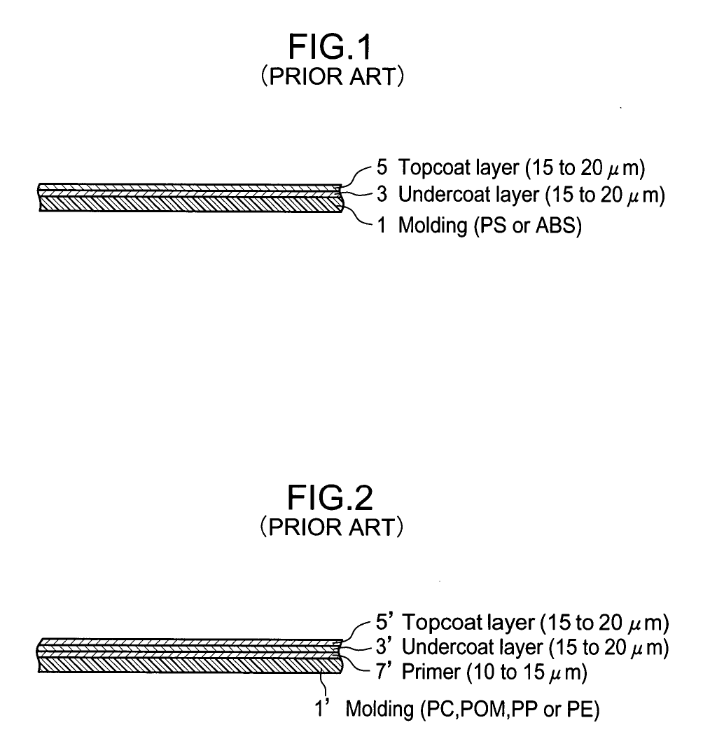

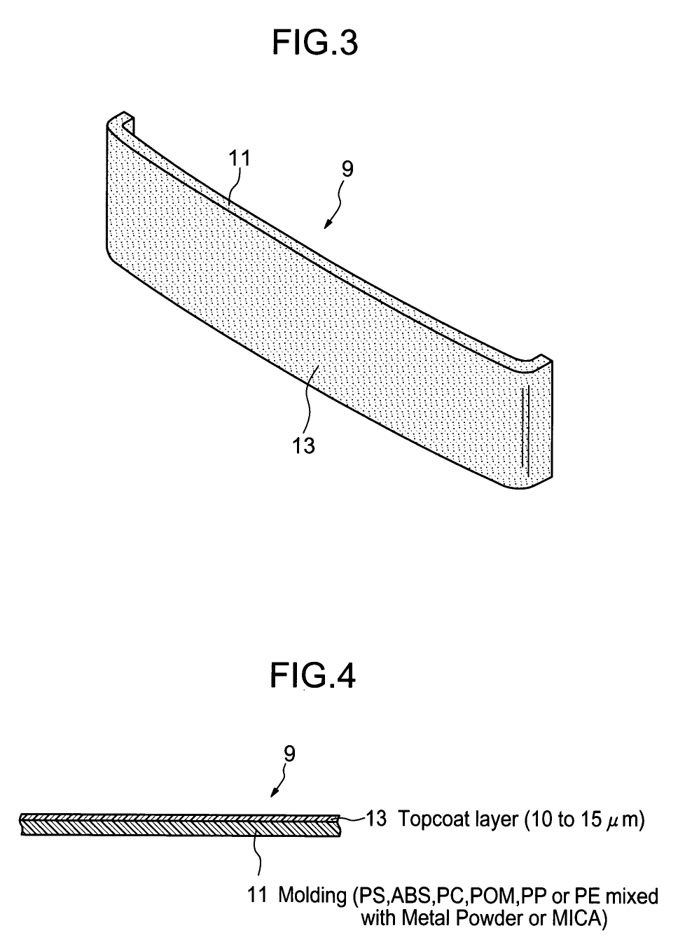

With reference to drawings, one embodiment of the present invention will now be described. FIG. 3 is a front perspective general view of a bumper 9 for vehicles such as a typical automobile. A coat layer of the bumper 9 is shown in FIG. 4 to facilitate understanding of the difference from the coat layers of the conventional resin products in FIGS. 1 and 2. The bumper 9 is composed of a molding 11 and a topcoat layer 13. The molding 11 is molded by using a mixture of a fusible resin martial colored to a desired tone and particles such as pigment, metal powder or mica. The topcoat layer 13A is formed by applying a coating material on the surface of the molding 11, so as to provide the bumper 9.

As seen in comparison between FIG. 3 showing this embodiment and FIGS. 1 and 2 showing the conventional resin products, the final products in FIGS. 1 and 2 have two or more coat layers applied on the molding 1, 1′, which causes increase in thickness of the final products. In the final product according to this embodiment, the coating material is applied on the surface of the molding 11 only once to allow the final product to be formed thinner. In this embodiment, the thickness of the topcoat layer 13 is in the range 10 to 15μ. The coating material to be used in this embodiment may be any suitable transparent coating material such as acrylic resin coating, acrylic/urethane resin coating, melamine/acrylic resin coating or transparent UV coating.

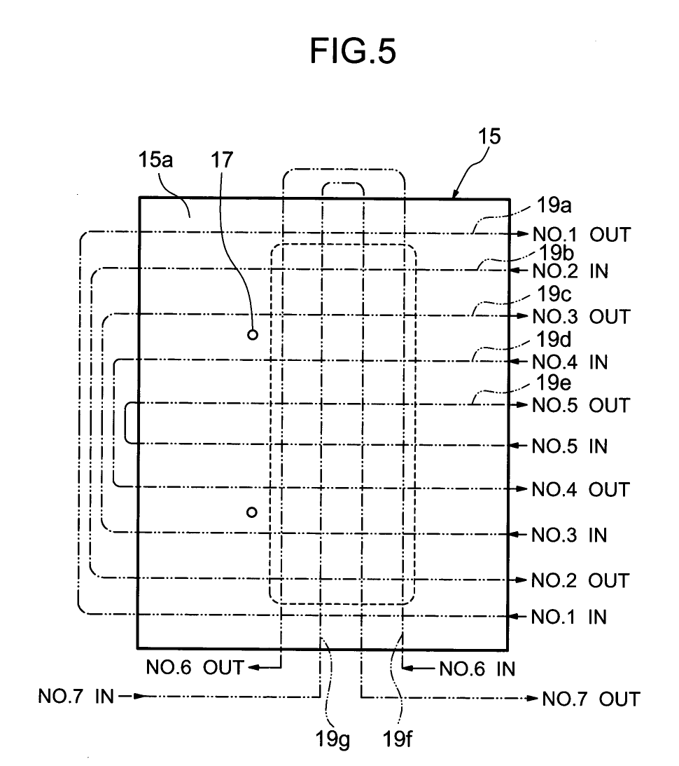

With reference to FIGS. 5 to 7, a molding die 15 for forming the molding 11 of the bumper 9 according to the present invention, through a resin injection molding process.

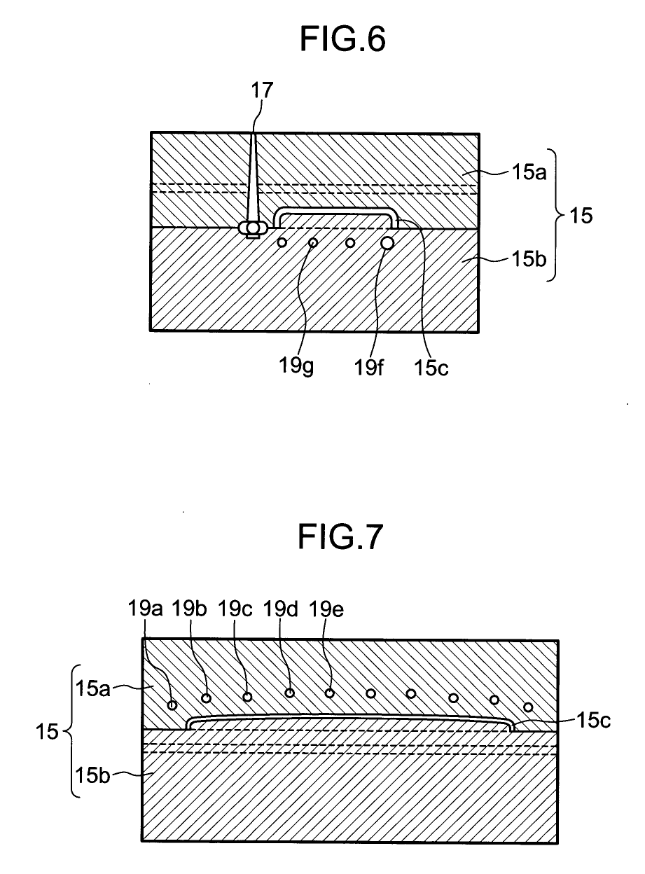

FIG. 5 is a top plan view of the molding die 15 for forming the molding 11 of the bumper 9, and FIGS. 6 and 7 are cross and longitudinal sectional views of the molding die 9, respectively. The molding die 15 comprises an upper-die-half 15a and a lower-die-half 15b, and a molding cavity 15c is defined between the upper-die-half 15a and the lower-die-half 15b. The upper-die-half 15a is formed with an injection gate 17 for injecting therethrough a fusible resin material in its molten state (hereinafter referred to as “molten resin material”) into the cavity 15c. The relative positions of these elements are shown in FIGS. 5 to 7. While the molding die 15 in this embodiment also includes a spool for first receiving the molten resin material from an injection nozzle of an injection molding machine and a runner for guiding the molten resin material from the spool to the gate 17, these element are not shown in the figures.

The molding die 15 is provided with a plurality of ducts 19 for selectively cooling or heating the molding die 15. Instead of specifically illustrating the ducts 19, FIG. 5 shows the flows of a cooling medium or a heating medium which flows through the ducts 19, by two dot chain lines with arrows. In this embodiment, the molding die 15 has two ducts 19f, 19g (port Nos. 6 and 7) extending in the longitudinal direction of the molding die, and five ducts 19a to 10e (port Nos. 1 to 5) extending in the crosswise direction of the molding die, or total seven ducts. Each of the ducts may be composed of a rubber hose. The cooling or heating medium is controlled to flow along the directions of the arrows shown at the ports Nos. 1 to 7, or from IN of each of the ports to OUT of the corresponding port. The temperature of the molding die 15 may be adjusted by using a die temperature controller (not shown) operable to selectively supply the cooling or medium to the ducts. The die temperature controller may include a tank for containing a heat transfer medium, a heating section for electrically hating the heat transfer medium, and a circulating pump for circulating the heat transfer medium.

In this embodiment of the present invention, the fusible resin material to be injected into the molding cavity 15 of the molding die 15 is a transparency lustrous resin material, preferably a colored resin material, and the particles of lustrous material are mixed with the fusible resin material. The resin material may be selected from various resin material such as polystyrene resin, polycarbonate resin, ABS resin, polyacetal resin, polypropylene resin and polyethylene resin. The particles of lustrous material may be particles of pigment, metal such as aluminum, copper or brass, or micaceous mineral such as mica. Preferably, the particles have a size of 5 to 30μ. The particles of lustrous material are mixed with the resin material preferably at 5 to 10 weight % on the basis of the total weight.

The molten resin material with the particles of lustrous material is injected into the cavity 15c from the gate through the spool and runner. In this embodiment, the injection time is set at about 4 to 5 seconds. As described above, the surface luster of a molding is dependent on the temperature of a molding die, and thus a higher luster can be obtained by increasing the temperature of the molding die. From this point of view, the temperature control of the molding die is critical to the present invention. Thus, in advance of injecting the molten resin material into the cavity 15c, the molding die 15 is adjusted to have a given temperature fairly higher than that in an ordinary molding condition to be set depending on a molding material to be used. For example, when a resin material, such as polystyrene resin or polyethylene resin, having an ordinary molding condition where a molding die is set at a temperature of 40 to 50° C., is used, the molding die 15 is adjusted to have a given temperature fairly higher than this temperature. In this embodiment, the molding die 15 is set at a temperature of 70 to 150° C., with a temperature of 80 to 90° C. being preferred. In order to obtain this temperature, hot water or steam having a temperature of about 80 to 150° C. is supplied into the ducts 19. Then, the molten resin material is injected into the cavity 15c for a given time while maintaining the above temperature of the molding die 15. After the completion of the injection process, it is necessary to cool the molding die to have a given temperature of 60 to 70° C. so as to cure the resin material in the cavity 15c to form a molding. Thus, a cooling water having a temperature of about 40 to 50° C. is supplied into the ducts 19 in place of the hot water. When polycarbonate rein or polyacetal is used as the resin material, the temperature of a molding die is set in the range of 70 to 90° C. in an ordinary molding condition. In this embodiment, the molding die 15 is adjusted to have a higher temperature than this temperature by the aforementioned die temperature controller (not shown). After taking the molding out of the molding die, the medium to be supplied into the ducts is switched from the cooling water to the hot water to set for a subsequent molding process.

When the molding die is adjusted at a temperature of 80° C. or loss, water may be used as the heat transfer medium. When the molding die is adjusted at a higher temperature than 80° C., the heat transfer medium may be mineral oil or heat-resistant heat transfer medium having a higher boiling point than that of water, or steam. The heat transfer medium will be selected according to the temperature of the molding die to be determined as a molding condition for a fusible resin material to be used.

The molding obtained through the above process is provides as a product having the desired color and a metallic or pearl appearance. Then, this product is finished into a final product by applying a transparent coating material directly on the surface of the molding to form a topcoat layer thereon. The coating material may be applied only once, and the thickness of the topcoat layer may be in the range of about 10 to 15μ. While the coating material may be a transparent material selected from the group consisting of acrylic resin coating, acrylic/urethane resin coating, melamine/acrylic resin coating and transparent UV coating, the present invention is not limited thereto.

In the method of the present invention, when a molding is formed through the method, it already has a metallic or pearl appearance, because the particles of pigment, metal powder, mica or the like are mixed in advance with the resin material colored to a desired tone. Thus, a highly lustrous final product can be obtained through a final finishing process of applying a coating material only once without applying any undercoating material as in the conventional coating process, and the entire process of forming a resin product can be simplified.

In addition, according to the present invention, a topcoat layer is formed directly on the surface of a molding without forming any undercoat or primer layer as in the conventional coating process. This simplified process can prevent occurrence of spots caused by the attachment of foreign particles or the invasion of dirt to provide a finally finished product with an excellent surface smoothness and a highly lustrous appearance. By virtue of the process devoid of the step of forming the undercoat or primer layer, the present invention also brings out a significant advantage of allowing the production cost of the molding to be reduced.

While the resin product forming method of the present invention has been described in connection with one specific embodiment concerning a method of forming a bumper of a typical automobile, the present invention is not limited to such a method of forming an exterior component for automobiles. That is, use of the method of the present invention in forming any component such as an interior or exterior component for automobiles, an exterior component for motorcycles, a frame for TV sets or personal computers, an exterior panel for portable phones or other phones, will be encompassed within the scope of the present invention. Further, any decorative plastics product formed through the above method will also be encompassed within the scope of the present invention.

What is claimed is:

1. A method of forming a highly lustrous decorative plastics product by using a fusible resin material to be injected into a molding cavity of a molding die provided with a plurality of ducts for selectively cooling or heating said molding die, said method comprising the steps of:
mixing particles of lustrous material with a fusible resin material colored to a desired tone;
allowing a heating medium to flow through said ducts of said molding die in such manner that said molding die is rapidly heated to have a first temperature higher than that in an ordinary molding condition to be set for said fusible resin material;
injecting said resin material in its molten state into said molding cavity while maintaining said first temperature of said molding die; and
in response to the completion of the injection of said molten resin material, allowing a cooing medium to flow through said ducts in such manner that said molding die is rapidly cooled to have a second temperature lower than said first temperature.

2. The method as defined in claim 1, wherein said first and second temperatures of said molding die are varied according to the kind of said fusible resin material.

3. The method as defined in claim 1, wherein said plurality of ducts are disposed to allow said cooling medium or said heating medium to flow in both the longitudinal and crosswise directions of said molding die.

4. The method as defined in either one of claims 1 to 3, wherein each of said cooling medium and said heating medium is either one selected from the group consisting of water, steam and oil.

5. The method as defined in claim 1, wherein said particle is made of a material selected from the group consisting of pigment, lustrous metal and micaceous mineral.

6. The method as defined in either one of claims 1 to 5, which further includes the step of applying a transparent coating material onto the surface of a molding obtained through said molding steps to form a topcoat layer thereon.

7. The method as defined in claim 6, wherein said topcoat layer has a thickness of 10 to 15 micrometer.

8. An decorative plastics product formed through the method as defined in either one of claims 1 to 7.

9. The decorative plastics product as defined in claim 8, which is either one selected from the group consisting of an interior or exterior component for automobiles, an exterior component for motorcycles, a frame for TV sets or personal computers, an exterior panel for portable phones or other phones.
